(19) United States
(12) Patent Application Publication
(10) Pub. No.: US 2020/0209168 A1
(43) Pub. Date: Jul. 2, 2020

(54) SEMICONDUCTOR TESTING METHOD AND TESTING APPARATUS

(71) Applicants: HKC CORPORATION LIMITED, Shenzhen (CN); CHONGQING HKC OPTOELECTRONICS TECHNOLOGY CO., LTD., Chongqing (CN)

(72) Inventors: En-Tsung CHO, Chongqing (CN); Kun FAN, Chongqing (CN)

(21) Appl. No.: 16/633,586

(22) PCT Filed: Jul. 31, 2018
(86) PCT No.: PCT/CN2018/097808

§ 371 Date: Jan. 24, 2020

(30) Foreign Application Priority Data
Aug. 1, 2017 (CN) 201710644520. X

(51) Int. Cl. G01N 22/00

(52) U.S. Cl. CPC G01N 22/00; G01N 2033/0095

(57) ABSTRACT

Disclosed by the embodiments of the present application are a semiconductor testing method and testing device; the testing method comprises the steps of: exciting a test sample by means of a pulse laser to generate a photoconductive effect; detecting weak information of the photoconductive effect; obtaining a composite lifetime of unbalanced carriers of the test sample by means of analyzing the photoconductive effect and the weak information. The testing device comprises: a pulse laser emitter, a microwave generator, a microwave receiver, and a calculation device.

### FIELD

Embodiments of this disclosure relate to the field of display technologies, and more particularly relate to a semiconductor test method and test apparatus.

### BACKGROUND

A carrier lifetime refers to a lifetime of a non-equilibrium carrier. Non-equilibrium carriers are generally non-equilibrium minority carriers (because only minority carriers can be injected into a semiconductor and accumulated, and majority carriers disappear quickly due to a Coulomb effect even if they are injected into a semiconductor). Therefore, the non-equilibrium carrier lifetime also refers to a non-equilibrium minority carrier lifetime, that is, a minority carrier lifetime. For example, for an n-type semiconductor, the non-equilibrium carrier lifetime also refers to a lifetime of a non-equilibrium hole.

For a bipolar semiconductor device that works mainly relying on minority carrier transmission (mainly diffusion), the minority carrier lifetime is an important parameter directly affecting device performance. In this case, a related parameter usually employed is a minority carrier diffusion length L (which is equal to a square root of a product of a diffusion coefficient and a lifetime), where L represents an average distance by which a diffusing minority carrier can travel during recombination. The longer minority carrier lifetime indicates the longer diffusion length.

For a bipolar junction transistor (BJT), in order to guarantee as little recombination of minority carriers as possible in a base region (to obtain a large current amplification coefficient), it is necessary to reduce the width of the base region below the diffusion length of the minority carriers. Therefore, a longer lifetime of minority carriers in the base region may be preferred.

Different semiconductor devices have different requirements on the carrier recombination lifetime. Therefore, how to accurately measure the carrier recombination lifetime of a semiconductor material is extremely important.

It should be noted that the background above is merely introduced to facilitate clear and complete description of the technical solutions of this disclosure and is set forth to help persons skilled in the art understand this disclosure. It is improper to consider that the foregoing technical solutions are well known to persons skilled in the art just because the solutions are set forth in the background of this disclosure.

### SUMMARY

A technical problem that embodiments of this disclosure first need to resolve is to provide a semiconductor material test method of detecting a non-equilibrium carrier recombination lifetime of a semiconductor.

A technical problem that the embodiments of this disclosure further need to resolve is to provide a test apparatus using a semiconductor material test method for detecting a non-equilibrium carrier recombination lifetime of a semiconductor.

An embodiment of this disclosure first provides a semiconductor material test method, including the following steps:

activating a test sample by using a pulse laser to generate a photoconductive effect;

detecting decay information of the photoconductive effect; and

obtaining a recombination lifetime of non-equilibrium carriers of the test sample by analyzing the photoconductive effect and the decay information.

Further, before the step of activating a test sample by using a pulse laser to generate a photoconductive effect, the method further includes:

detecting initial conductivity σ₀ of the test sample and a corresponding initial microwave signal V₀. In this embodiment, because the semiconductor test sample has initial conductivity and an initial microwave signal V₀, the detection of the initial conductivity and initial microwave signal in this solution helps improve test precision of this disclosure.

Further, the step of activating a test sample by using a pulse laser to generate a photoconductive effect includes:

detecting conductivity σ and a microwave signal V of the test sample, obtaining Δσ according to a formula σ=σ0+Δσ, and obtaining ΔV according to a formula V=V₀+ΔV.

Δσ is a variation in the photoconductivity, and ΔV is a variation in the microwave signal. In this embodiment, due to activation of the pulse laser, electron-hole pairs will be generated inside the semiconductor test sample, and photo-conductance is generated, which results in a change in microwave reflectivity, thereby causing the microwave signal V to change. In this solution, the variation of the microwave signal V can be obtained through detection, and the detection facilitates subsequent calculation and can improve the test precision.

Further, an effect formula of the photoconductive effect is:

Δσ=q(Δnμₑ+Δpμₚ), where Δσ is the variation in the photoconductivity, q is an electron charge, Δn is concentration of electrons generated by laser activation, Δp is hole concentration, μₑ is electron mobility, and μₚ is hole mobility. In this embodiment, an effect formula corresponding to the photo-conductance is Δσ=q(Δnμₑ+Δpμₚ). Because electrons and holes are generally generated in pairs, Δn=Δp.

Further, the step of detecting decay information of the photoconductive effect includes:

detecting the decay information of the photoconductive effect by microwave reflectance.

The decay signal includes: an exponential decay curve of the microwave signal V, which has the following formula:

V=V₀*e^{-t/τ}, where V₀ refers to the initial microwave signal, t refers to a pulse laser shutdown time, and τ refers to an average survival time of non-equilibrium carriers before recombination, which is referred to as a non-equilibrium carrier recombination lifetime. In this embodiment, the conductive effect and such a decay process that the non-equilibrium carriers will gradually disappear through recombination can be detected in the microwave manner, and a recombination lifetime of the semiconductor test sample can be obtained by analyzing the photoconductive effect and the variation curve of the microwave signal V.

Further, the pulse laser has a wavelength of 249 nm to 449 nm.

Further, the pulse laser has a wavelength of 349 nm.

Further, the microwave reflectance is implemented by a controllable microwave source, and the controllable microwave source uses a microwave having a wavelength of 24 to 26 GHz.

An embodiment of this embodiment further provides a test apparatus using the semiconductor material test method described above, and the apparatus includes:

a pulse laser transmitter, configured to activate a test sample to generate a photoconductive effect;

a microwave generator, configured to detect decay information of the photoconductive effect;

a microwave receiver, configured to receive the decay information; and

a calculation device, configured to obtain a recombination lifetime of non-equilibrium carriers of the test sample by analyzing the photoconductive effect and the decay information. In this embodiment, the test apparatus actually can further include structures such as a phase sensitive detector, a circutator and a waveguide. In addition, the test apparatus can further include a calculation device configured to calculate an exponential decay curve of the microwave signal V.

Further, the microwave generator uses a controllable microwave source having a wavelength of 24 to 26 GHz; and

the pulse laser transmitter uses a pulse laser having a wavelength of 349 nm.

An embodiment of this disclosure further provides a test apparatus, including:

a pulse laser transmitter, configured to transmit a first laser beam, to activate a test sample to generate a photoconductive effect;

a microwave generator, configured to transmit a microwave;

a splitter, configured to split the microwave from the microwave generator into a first microwave and a second microwave, and output the first microwave and the second microwave;

a circulator, configured to transmit the second microwave from the splitter to the test sample, and output the second microwave reflected by the test sample; and

a detector, configured to detect and compare the first microwave from the splitter and the second microwave that is from the circulator and that is reflected by the test sample, to generate decay information.

Further, before the first laser beam is incident on the test sample, the first microwave is incident on the test sample through the splitter and the circulator, and after the first laser beam is incident on the test sample, the second microwave is incident on the test sample through the splitter and the circulator.

Further, the microwave generator is configured to transmit the microwave after the first laser beam is incident on the test sample, the microwave is split by the splitter into the first microwave and the second microwave that are identical, the first microwave is directly output by the splitter to the detector and therefore is not incident on the test sample, and the second microwave sequentially passes through the splitter and the circulator and is incident on the test sample.

Further, the test apparatus further includes a calculation device, configured to obtain a recombination lifetime of non-equilibrium carriers of the test sample by analyzing the photoconductive effect and the decay information.

Further, the test sample includes an insulating substrate and a conductive film arranged on the insulating substrate, and the photoconductive effect occurs in the conductive film.

Further, the test apparatus further includes a feedback and adjustment device, configured to store predetermined decay information; the feedback and adjustment device further compares the predetermined decay information and the decay information from the detector, and adjusts, according to a comparison result, the pulse laser transmitter to generate a second laser beam different from the first laser beam.

Further, the detector includes a phase detector, configured to detect a phase shift between the first microwave and the second microwave.

Further, the detector includes an amplitude detector, configured to detect an amplitude difference between the first microwave and the second microwave.

Further, the microwave generator uses a controllable microwave source having a wavelength of 24 to 26 GHz.

Further, the first laser beam used by the pulse laser transmitter has a wavelength of 349 nm.

In the test method in this disclosure, a semiconductor test sample is activated by using a pulse laser, so that electron-hole pairs are generated in the test sample, that is, a photoconductive effect is generated; and the pulse laser is shut down after a demand is met. In this way, non-equilibrium carriers in the semiconductor test sample will gradually disappear through recombination due to a difference between a recombination rate and a generation rate if the activation by the pulse laser is canceled. The conductive effect and such a decay process that the non-equilibrium carriers will gradually disappear through recombination can be detected by means of microwave reflectance, thereby obtaining a non-equilibrium carrier recombination lifetime of the semiconductor test sample. The whole test process is carried out in a non-contact manner. Because different devices such as a silicon monocrystalline rod, a transistor and a switch tube have different requirements on a semiconductor and a lifetime of the semiconductor, detection of the recombination lifetime allows related devices to achieve better effects. The non-contact non-pollution test process helps improve the test precision.

### BRIEF DESCRIPTION OF THE DRAWINGS

The accompanying drawings incorporated are used to provide further understanding of the embodiments of this disclosure. The drawings, as a part of the specification, are used to illustrate the embodiments of this disclosure, and explain the principle of this disclosure together with the text description. Obviously, the drawings in the following description are only some of the embodiments of this disclosure. In the drawings:

FIG. 1 is a flowchart of a semiconductor material test method according to an embodiment of this disclosure;

FIG. 2 is a schematic diagram of a test process of a test method according to an embodiment of this disclosure;

FIG. 3 is a schematic diagram of a semiconductor material test apparatus according to an embodiment of this disclosure;

FIG. 4 is a schematic diagram of a semiconductor material test apparatus according to another embodiment of this disclosure; and

FIG. 5 is a schematic diagram of a semiconductor material test apparatus according to still another embodiment of this disclosure.

### DETAILED DESCRIPTION OF THE EMBODIMENTS

With reference to the following description and drawings, specific embodiments of this disclosure are disclosed in detail, and the manner in which the principle of this disclosure can be adopted is pointed out. It should be understood that the scope of the embodiments of this disclosure is not thus limited. In the scope of the principle and items of the appended claims, the embodiments of this disclosure include many changes, modifications and equivalents.

Features described and/or shown in one embodiment can be used in one or more other embodiments in the same manner or a similar manner, be combined with features in other embodiments, or replace features in other embodiments.

It should be emphasized that when used in this specification, the term “include/comprise” refers to the presence of features, whole devices, steps or components, but does not preclude the presence or addition of one or more other features, whole devices, steps or components.

Specific structures and functional details disclosed herein are merely representative, and are intended to describe the objectives of the exemplary embodiments of this disclosure. However, this disclosure may be specifically implemented in many alternative forms, and should not be construed as being limited to the embodiments set forth herein.

In the description of this disclosure, it should be understood that orientation or position relationships indicated by the terms such as “center”, “transverse”, “on”, “below”, “left”, “right”, “vertical”, “horizontal”, “top”, “bottom”, “inside”, and “outside” are based on orientation or position relationships shown in the accompanying drawings, and are used only for ease and brevity of illustration and description, rather than indicating or implying that the mentioned apparatus or component may have a particular orientation or may be constructed and operated in a particular orientation. Therefore such terms should not be construed as limiting of this disclosure. In addition, the terms such as “first” and “second” are used only for the purpose of description, and should not be understood as indicating or implying the relative importance or implicitly specifying the number of the indicated technical features. Therefore, a feature defined by “first” or “second” can explicitly or implicitly include one or more of said features. In the description of this disclosure, unless otherwise stated, “a plurality of” means two or more than two. In addition, the terms “include”, “comprise” and any variant thereof are intended to cover non-exclusive inclusion.

In the description of this disclosure, it should be noted that unless otherwise explicitly specified or defined, the terms such as “mount”, “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components.

The terminology used herein is for the purpose of describing specific embodiments only and is not intended to be limiting of exemplary embodiments. As used herein, the singular forms “a”, “an” and “the” are intended to include the plural forms as well, unless the context clearly indicates otherwise. It should be further understood that the terms “include” and/or “comprise” when used in this specification, specify the presence of stated features, integers, steps, operations, elements, and/or components, but do not preclude the presence or addition of one or more other features, integers, steps, operations, elements, components, and/or combinations thereof.

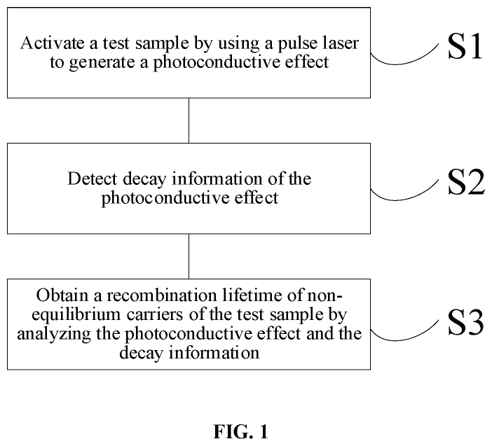

FIG. 1 is a flowchart of a semiconductor material test method according to an embodiment of this disclosure. The method includes the following steps:

S1: Activate a test sample by using a pulse laser to generate a photoconductive effect.

S2: Detect decay information of the photoconductive effect.

S3: Obtain a recombination lifetime of non-equilibrium carriers of the test sample by analyzing the photoconductive effect and the decay information.

Specifically, the test sample is activated by using a pulse laser, so that electron-hole pairs are generated in the test sample, generating a photoconductive effect.

In the test method in this embodiment of this disclosure, a semiconductor test sample is activated by using a pulse laser, so that electron-hole pairs are generated in the test sample, that is, a photoconductive effect is generated; and the pulse laser is shut down after a demand is met. In this way, non-equilibrium carriers in the semiconductor test sample will gradually disappear through recombination due to a difference between a recombination rate and a generation rate if the activation by the pulse laser is canceled. The photoconductive effect and such a decay process that the non-equilibrium carriers will gradually disappear through recombination can be detected by means of microwave reflectance, obtaining a non-equilibrium carrier recombination lifetime of the semiconductor test sample. The whole test process is carried out in a non-contact manner. Because different devices such as a silicon monocrystalline rod, a transistor and a switch tube have different requirements on a semiconductor and a lifetime of the semiconductor, detection of the recombination lifetime allows related devices to achieve better effects. The non-contact non-pollution test process helps improve the test precision.

The semiconductor in this embodiment of this disclosure may refer to an active-layer thin film that includes n+-SixGey, p+-SixGey, Nn-doped SiGe-rich SixGeyOz, p-doped SiGe-rich SixGeyOz n+ or p+-layer, and SixGey and SiGe-rich SixGeyOx. In the method in this embodiment of this disclosure, the semiconductor can be detected in a non-destructive manner without touching the semiconductor and without causing any pollution. Definitely, the test method in this embodiment of this disclosure is also applicable to other semiconductor materials in appropriate situations. In the field of display technologies, active switches in display panels are mostly manufactured by using semiconductor materials. Therefore, the technical solution in this embodiment of this disclosure is also widely applied in the field of display technologies.

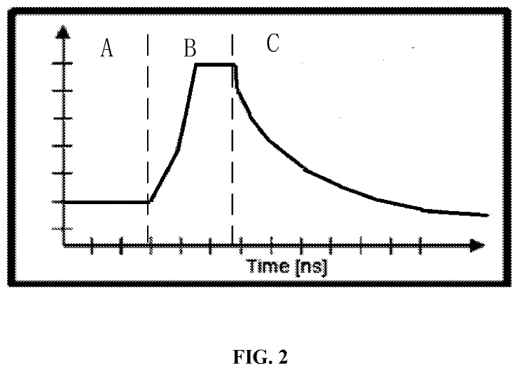

FIG. 2 is a schematic diagram of a test process of a test method according to an embodiment of this disclosure, where the ordinate axis corresponds to a microwave signal V, and the abscissa axis corresponds to time. Referring to FIG. 2 in combination with FIG. 1, it can be known that in this embodiment, before the step of activating a test sample by using a pulse laser to generate a photoconductive effect, the method further includes:

detecting initial conductivity σ₀ of the test sample and a corresponding initial microwave signal V₀. In this embodiment, because the semiconductor test sample has initial conductivity and an initial microwave signal V₀, the detection of the initial conductivity and initial microwave signal in this solution helps improve test precision of this disclosure. Stage A in FIG. 2 corresponds to a stage prior to injection of the pulse laser, and at this point, the test sample has the initial conductivity σ₀ and the corresponding initial microwave signal V₀. The microwave signal is stable.

In this embodiment, the step of activating a test sample by using a pulse laser to generate a photoconductive effect includes:

detecting conductivity a and a microwave signal V of the test sample, obtaining Δσ according to a formula σ=σ0+Δσ, and obtaining ΔV according to a formula V=V₀+ΔV.

Δσ is a variation in the photoconductivity, and ΔV is a variation in the microwave signal. In this embodiment, due to activation of the pulse laser, electron-hole pairs will be generated inside the semiconductor test sample, and photo-conductance is generated, which results in a change in microwave reflectivity, causing the microwave signal V to change. In this solution, the variation of the microwave signal V can be obtained through detection, and the detection facilitates subsequent calculation and can improve the test precision. Stage B in FIG. 2 corresponds to a stage after injection of the pulse laser. The injection of the pulse laser activates the material content to generate electron-hole pairs as well as a photo-conductance phenomenon, resulting in a change in the microwave reflectivity and further causing a change in the microwave signal.

In this embodiment, an effect formula of the photoconductive effect is:

Δσ=q(Δnμₑ+Δpμₚ), where Δσ is the variation in the photoconductivity, q is an electron charge, Δn is concentration of electrons generated by laser activation, Δp is hole concentration, μₑ is electron mobility, and μₚ is hole mobility. In this embodiment, an effect formula corresponding to the photo-conductance is Δσ=q(Δnμₑ+Δpμₚ). Because electrons and holes are generally generated in pairs, Δn=Δp.

In this embodiment, the step of detecting decay information of a photoconductive effect includes:

detecting the decay information of the photoconductive effect by microwave reflectance.

The decay signal includes: an exponential decay curve of the microwave signal V, which has the following formula:

V=V₀*e^{-t/τ}, where V₀ refers to the initial microwave signal V₀, t refers to a pulse laser shutdown time, and τ refers to an average survival time of non-equilibrium carriers before recombination, which is referred to as a non-equilibrium carrier recombination lifetime. In this embodiment, the conductive effect and such a decay process that the non-equilibrium carriers will gradually disappear through recombination can be detected in the microwave manner, and a recombination lifetime of the semiconductor test sample can be obtained by analyzing the photoconductive effect and the variation curve of the microwave signal V. Stage C in FIG. 2 is a stage after the pulse laser is shut down. At this stage, the conductivity of the test sample is gradually reduced to zero due to Δσ. The non-equilibrium carriers in the material are gradually reduced to 0 due to the recombination concentration Δn thereof. The process is correspondingly demonstrated as the variation curve of the microwave signal V. The non-equilibrium carrier recombination lifetime can be obtained according to the variation curve. Definitely, it is also feasible to detect the decay information by using a method other than microwave reflectance, as long as the method is applicable.

In this embodiment, the pulse laser has a wavelength of 249 nm to 449 nm.

In this embodiment, the pulse laser has a wavelength of 349 nm.

In this embodiment, the microwave reflectance is implemented by a controllable microwave source, and the controllable microwave source uses a microwave having a wavelength of 24 to 26 GHz.

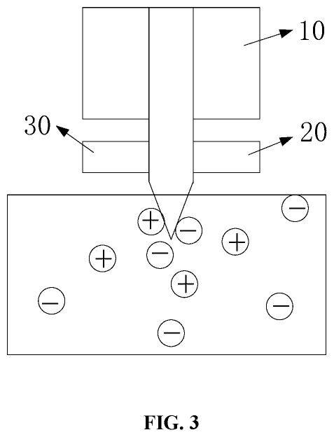

FIG. 3 is a schematic diagram of a test apparatus according to an embodiment of this disclosure. Referring to FIG. 3 in combination with FIG. 1 and FIG. 2, an embodiment of this disclosure further discloses a test apparatus using the semiconductor material test method described in any of the foregoing embodiments. The test apparatus includes:

a pulse laser transmitter 30, configured to activate a test sample to generate a photoconductive effect;

a microwave generator 10, configured to detect decay information of the photoconductive effect;

a microwave receiver 20, configured to receive the decay information; and

a calculation device (not shown in the figure), configured to obtain a recombination lifetime of non-equilibrium carriers of the test sample by analyzing the photoconductive effect and the decay information.

The test apparatus in this embodiment of this disclosure is used for implementing the test method disclosed in this disclosure. In the test method, a semiconductor test sample is activated by using a pulse laser, so that electron-hole pairs are generated in the test sample, that is, a photoconductive effect is generated; and the pulse laser is shut down after a demand is met. In this way, non-equilibrium carriers in the semiconductor test sample will gradually disappear through recombination due to a difference between a recombination rate and a generation rate if the activation by the pulse laser is canceled. The conductive effect and such a decay process that the non-equilibrium carriers will gradually disappear through recombination can be detected by means of microwave reflectance, obtaining a non-equilibrium carrier recombination lifetime of the semiconductor test sample. The whole test process is carried out in a non-contact manner. Because different devices such as a silicon monocrystalline rod, a transistor and a switch tube have different requirements on a semiconductor and a lifetime of the semiconductor, detection of the recombination lifetime allows related devices to achieve better effects.

In this embodiment, the test apparatus actually can further include structures such as a phase sensitive detector, a circutator and a waveguide. In addition, the test apparatus can further include a calculation device configured to calculate an exponential decay curve of the microwave signal V.

In addition, the microwave generator and the microwave receiver can be combined into a probe for implementation. Definitely, in an appropriate situation, the microwave generator, the microwave receiver and the pulse laser generator can be combined into one test apparatus for use. In this way, it is unnecessary to change the test apparatus multiple times in the test process, and it is only unnecessary to switch functions. In this way, a time error caused by apparatus changing can be reduced, improving the test precision.

In this embodiment, the microwave generator uses a controllable microwave source having a wavelength of 24 to 26 GHz.

The pulse laser transmitter uses a pulse laser having a wavelength of 349 nm.

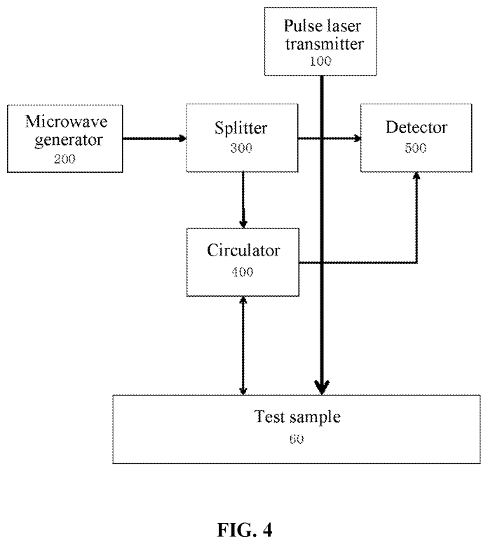

FIG. 4 is a schematic diagram of a semiconductor material test apparatus according to another embodiment of this disclosure. As shown in FIG. 4, a test apparatus provided in an embodiment of this disclosure includes: a pulse laser transmitter 100, a microwave generator 200, a splitter 300, a circulator 400 and a detector 500.

First, the pulse laser transmitter 100 can transmit a first laser beam to a test sample 60. For example, the first laser beam has a wavelength of 349 nm. For example, the test sample 60 can include an insulating substrate and a conductive film arranged on the insulating substrate. Through activation of the first laser beam transmitted by the pulse laser transmitter 100, a photoconductive effect can occur in the conductive film in the test sample 60.

After the first laser beam transmitted by the pulse laser transmitter 100 is incident on the test sample 60, the microwave generator 200 can transmit a microwave. For example, the microwave generator 200 uses a controllable microwave source having a wavelength of 24 to 26 GHz. The microwave transmitted by the pulse laser transmitter 100 is split by the splitter 300 into a first microwave and a second microwave that have identical features (for example, identical wavelengths, amplitudes and frequencies). The first microwave is directly output to the detector 500 through the splitter 300 and therefore is not incident on the test sample 60. The second microwave is incident on the test sample 60 from the splitter 300 through the circulator 400.

After the second microwave is incident on the test sample 60, the test sample 60 will reflect the second microwave. Next, the circulator 400 receives the second microwave reflected by the test sample 60 and outputs the received second microwave to the detector 500.

Finally, the detector 500 can detect and compare the first microwave from the splitter 300 and the second microwave that is from the circulator 400 and that is reflected by the test sample 60, to generate decay information. In one embodiment, the circulator 400 can also output, to the splitter 300, the second microwave reflected by the test sample 60, and then output the second microwave to the detector 500 through the splitter 300.

For example, the detector 500 can include a phase detector 500, an amplitude detector 500 or other suitable detectors. The phase detector 500 is configured to detect a phase shift between the first microwave and the second microwave. The amplitude detector 500 is configured to detect an amplitude difference between the first microwave and the second microwave.

In other words, in this embodiment, the detector 500 can compare a change between the first microwave output by the microwave generator 200 and the second microwave that is output by the microwave generator 200 and then reflected by the test sample 60 having a photo-conductive reaction. Next, for example, the test apparatus of this disclosure can further include a calculation device, configured to obtain a recombination lifetime of non-equilibrium carriers of the test sample 60 by analyzing the photoconductive effect and the decay information.

In this embodiment, the test apparatus can further include a feedback and adjustment device, configured to store predetermined decay information. Moreover, the feedback and adjustment device compares the stored predetermined decay information with the decay information from the detector 500, and adjusts, according to a comparison result, the pulse laser transmitter 100 to generate a second laser beam different from the first laser beam. The generated second laser beam can be incident on the test sample 60, so that the test sample 60 generates a photo-conductive reaction of a different degree.

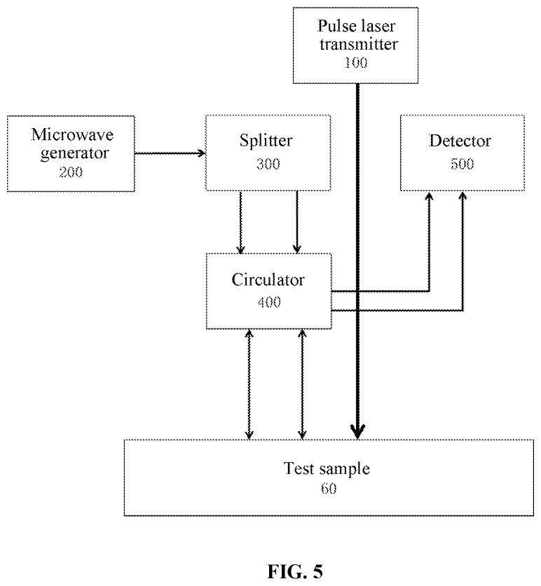

FIG. 5 is a schematic diagram of a semiconductor material test apparatus according to still another embodiment of this disclosure. As shown in FIG. 5, a test apparatus provided in an embodiment of this disclosure includes: a pulse laser transmitter 100, a microwave generator 200, a splitter 300, a circulator 400 and a detector 500.

First, the microwave generator 200 can transmit a microwave to the splitter 300. The splitter 300 splits the microwave from the microwave generator 200 into a first microwave and a second microwave having identical features (for example, identical wavelengths, amplitudes and frequencies). Before the pulse laser transmitter 100 transmits a first laser beam, the first microwave is incident on a test sample 60 from the splitter 300 through the circulator 400.

After the first microwave generated by the microwave generator 200 sequentially passes through the splitter 300 and the circulator 400 and is incident on the test sample 60, the test sample 60 reflects the first microwave. The circulator 400 receives the first microwave reflected by the test sample 60 and outputs the first microwave to the detector 500.

Next, the pulse laser transmitter 100 can transmit the first laser beam to the test sample 60, to activate a photoconductive effect in a conductive film of the test sample 60. After the first laser beam transmitted by the pulse laser transmitter 100 is incident on the test sample 60 and the photoconductive effect occurs in the conductive film of the test sample 60, a second microwave is incident on the test sample 60 from the splitter 300 through the circulator 400.

After the second microwave is incident on the test sample 60, the test sample 60 reflects the second microwave. Next, the circulator 400 receives the second microwave reflected by the test sample 60 and then outputs the received second microwave to the detector 500.

Finally, the detector 500 can detect and compare the first microwave reflected by the test sample 60 prior to the photo-conductive reaction and the second microwave reflected by the test sample 60 after the photo-conductive reaction activated by the laser beam, obtaining information such as a non-equilibrium carrier recombination lifetime.

In this embodiment, the test apparatus can further include a feedback and adjustment device, configured to store predetermined decay information. Moreover, the feedback and adjustment device compares the stored predetermined decay information with decay information from the detector 500, and adjusts, according to a comparison result, the pulse laser transmitter 100 to generate a second laser beam different from the first laser beam. The generated second laser beam can be incident on the test sample 60, so that the test sample 60 generates a photo-conductive reaction of a different degree.

The foregoing contents are detailed descriptions of this disclosure in conjunction with specific preferred embodiments, and it should not be considered that the specific implementation of this disclosure is limited to these descriptions. Persons of ordinary skill in the art can further make simple deductions or replacements without departing from the concept of this disclosure, and such deductions or replacements should all be considered as falling within the protection scope of this disclosure.

1. A semiconductor material test method, comprising:
activating a test sample by using a pulse laser to generate a photoconductive effect;
detecting decay information of the photoconductive effect; and
obtaining a recombination lifetime of non-equilibrium carriers of the test sample by analyzing the photoconductive effect and the decay information.

2. The semiconductor material test method according to claim 1, wherein before the activating of the test sample by using a pulse laser to generate a photoconductive effect, the method further comprises:
detecting initial conductivity σ₀ of the test sample and a corresponding initial microwave signal V₀.

3. The semiconductor material test method according to claim 2, wherein the activating the test sample by using a pulse laser to generate a photoconductive effect comprises:
detecting conductivity σ and a microwave signal V of the test sample, obtaining Δσ according to a formula σ=σ0+Δσ, and obtaining ΔV according to a formula V=V₀+ΔV, wherein
Δσ is a variation in photoconductivity, and ΔV is a variation in a microwave signal.

4. The semiconductor material test method according to claim 3, wherein an effect formula of the photoconductive effect is:
Δσ=q(Δnμₑ+Δpμₚ), wherein Δσ is the variation in the photoconductivity, q is an electron charge, Δn is concentration of electrons generated by laser activation, Δp is hole concentration, μₑ is electron mobility, and μₚ is hole mobility.

5. The semiconductor material test method according to claim 4, wherein the detecting decay information of the photoconductive effect comprises:
detecting the decay information of the photoconductive effect by microwave reflectance, wherein
a decay signal comprises: an exponential decay curve of the microwave signal V, which has the following formula:
V=V₀*e^{-t/τ}, wherein t refers to a pulse laser shutdown time, V₀ refers to an initial microwave signal, and τ refers to an average survival time of non-equilibrium carriers before recombination, which is referred to as a non-equilibrium carrier recombination lifetime.

6. The semiconductor material test method according to claim 1, wherein the pulse laser has a wavelength of 249 nm to 449 nm.

7. The semiconductor material test method according to claim 6, wherein the pulse laser has a wavelength of 349 nm.

8. The semiconductor material test method according to claim 1, wherein microwave reflectance is implemented by a controllable microwave source, and the controllable microwave source uses a microwave having a wavelength of 24 to 26 GHz.

9. A test apparatus, comprising:
a pulse laser transmitter, configured to activate a test sample to generate a photoconductive effect;
a microwave generator, in communication with the pulse laser transmitter and configured to detect decay information of the photoconductive effect;
a microwave receiver, in communication with the microwave generator and configured to receive the decay information; and
a calculation device, in communication with the microwave generator and microwave receiver and configured to obtain a recombination lifetime of non-equilibrium carriers of the test sample by analyzing the photoconductive effect and the decay information.

10. The test apparatus according to claim 9, wherein the microwave generator uses a controllable microwave source having a wavelength of 24 to 26 GHz; and
the pulse laser transmitter uses a pulse laser having a wavelength of 349 nm.

11. A test apparatus, comprising:
a pulse laser transmitter, configured to transmit a first laser beam, to activate a test sample to generate a photoconductive effect;
a microwave generator, configured to transmit a microwave;
a splitter, configured to split the microwave from the microwave generator into a first microwave and a second microwave, and output the first microwave and the second microwave;
a circulator, configured to transmit the second microwave from the splitter to the test sample, and output the second microwave reflected by the test sample; and
a detector, configured to detect and compare the first microwave from the splitter and the second microwave that is from the circulator and that is reflected by the test sample, to generate decay information.

12. The test apparatus according to claim 11, wherein before the first laser beam is incident on the test sample, the first microwave is incident on the test sample through the splitter and the circulator, and after the first laser beam is incident on the test sample, the second microwave is incident on the test sample through the splitter and the circulator.

13. The test apparatus according to claim 11, wherein the microwave generator is configured to transmit the microwave after the first laser beam is incident on the test sample, the microwave is split by the splitter into the first microwave and the second microwave that are identical, the first microwave is directly output by the splitter to the detector and therefore is not incident on the test sample, and the second microwave sequentially passes through the splitter and the circulator and is incident on the test sample.

14. The test apparatus according to claim 11, wherein the test apparatus further comprises a calculation device, configured to obtain a recombination lifetime of non-equilibrium carriers of the test sample by analyzing the photoconductive effect and the decay information.

15. The test apparatus according to claim 11, wherein the test sample comprises an insulating substrate and a conductive film arranged on the insulating substrate, and the photoconductive effect occurs in the conductive film.

16. The test apparatus according to claim 11, wherein the test apparatus further comprises a feedback and adjustment device, configured to store predetermined decay information; the feedback and adjustment device further compares the predetermined decay information and the decay information from the detector, and adjusts, according to a comparison result, the pulse laser transmitter to generate a second laser beam different from the first laser beam.

17. The test apparatus according to claim 11, wherein the detector comprises a phase detector, configured to detect a phase shift between the first microwave and the second microwave.

18. The test apparatus according to claim 11, wherein the detector comprises an amplitude detector, configured to detect an amplitude difference between the first microwave and the second microwave.

19. The test apparatus according to claim 11, wherein the microwave generator uses a controllable microwave source having a wavelength of 24 to 26 GHz.

20. The test apparatus according to claim 11, wherein the first laser beam used by the pulse laser transmitter has a wavelength of 349 nm.
